(19) United States
(12) Patent Application Publication
(10) Pub. No.: US 2026/0104588 A1
(43) Pub. Date: Apr. 16, 2026

(54) DISPLAY WITH A REFLECTOR FILM

(71) Applicant: Harman International Industries, Incorporated, Stamford, CT (US)

(72) Inventors: Taeseung LEE, Suwon (KR); Daehyoun BYUN, Seoul (KR); Jungbae JEON, Suwon (KR); Haewon YOU, Suwon (KR)

(73) Assignee: Harman International Industries, Incorporated, Stamford, CT (US)

(21) Appl. No.: 19/422,007

(22) Filed: Dec. 16, 2025

Related U.S. Application Data
(63) Continuation of application No. PCT/US2023/076602, filed on Oct. 11, 2023.

(30) Foreign Application Priority Data
Jun. 21, 2023 (US) 63515004

(51) Int. Cl. G02B 27/01; B60K 35/231; B60K 35/65; G02B 5/09; G02B 5/10

(52) U.S. Cl. CPC G02B 27/0101; B60K 35/231; B60K 35/656; G02B 27/0149; B60K 2360/23; B60K 2360/334; G02B 5/09; G02B 5/10; G02B 2027/013; G02B 2027/0161; G02B 2027/0169

(57) ABSTRACT

A system includes an interface having a first orientation. The first orientation defines a geometric plane and the interface has a substantially planar distribution over the geometric plane. The interface is configured to receive light. The light is representative of an image. The system also includes a reflector. The reflector has a principal plane. The principal plane has a second orientation different from the first orientation. The principal plane defines an angle of incidence based on the light and an angle of reflection based on the light.

### CROSS-REFERENCE TO RELATED APPLICATIONS

This application claims priority to and the benefit of U.S. application No. 63/515,004 filed on Jul. 21, 2023. The disclosure of the above application is incorporated by reference herein.

### FIELD

The present disclosure relates to a display device with a reflector film.

### BACKGROUND

The statements in this section merely provide background information related to the present disclosure and do not constitute prior art.

A display device can provide information on a windshield of a vehicle that can be viewed by a driver of the vehicle while operating the vehicle. The windshield being transparent may not be able to reflect the image efficiently and effectively. Thus, in some configurations, in order to display the image on the windshield, a reflective film or coating is provided on the windshield, which adds complexity to the manufacturing of the windshield.

### SUMMARY

This section provides a general summary of the disclosure and is not a comprehensive disclosure of its full scope or all of its features.

In one or more forms, a system includes an interface having a first orientation. The first orientation defines a first geometric plane and the interface has a substantially planar distribution over the first geometric plane. The interface is configured to receive light, wherein the light is representative of an image. The system also includes a first reflector. The first reflector has a first principal plane. The first principal plane has a second orientation different from the first orientation. The first principal plane defines a first angle of incidence based on the light and a first angle of reflection based on the light.

In one or more forms, the system includes a first structure configured to orient the first reflector with respect to the interface. The first structure forms an incline with respect to the interface and the incline orients the first reflector.

In one or more forms, the incline has a third orientation, the third orientation different from the first orientation and the second orientation, and a direction of the first angle of reflection is toward a windshield.

In one or more forms, the system includes a dashboard. The projector and the interface are installed as part of the dashboard and a direction of the first angle of reflection is toward a windshield. A direction of the first angle of reflection is toward an intersection between a range of view based on a passenger of a vehicle and the windshield of the vehicle.

In one or more forms, the system includes a second reflector having a second principal plane. The second principal plane has a third orientation different form the first orientation and different from the second orientation. The second principal plane defines a second angle of incidence based on the light and a second angle of reflection based on the light.

In one or more forms, the system includes a first structure configured to orient the first reflector with respect to the interface and the second reflector with respect to the interface. The first structure forms an incline with respect to the interface to orient the first reflector and the second reflector, and the incline has a fourth orientation, the fourth orientation different from the first orientation, the second orientation, and the third orientation.

In one or more forms, the system includes a first structure configured to orient the first reflector with respect to the interface, and a second structure configured to orient the second reflector with respect to the interface. The first structure forms a first incline with respect to the interface to orient the first reflector. The first incline having a fourth orientation, the fourth orientation different from the first orientation, the second orientation, and the third orientation, and wherein the second structure forms a second incline with respect to the interface to orient the second reflector, the second incline having a fifth orientation, the fifth orientation different from the first orientation, the second orientation, the third orientation, and the fourth orientation. A direction of the first angle of reflection is toward an intersection between a range of view based on a passenger of a vehicle and a windshield of the vehicle and a direction of the second angle of reflection is toward the intersection. A geometry of the intersection comprises four corners. The four corners are arranged across the windshield of the vehicle. In one or more forms, the second reflector is convex, and the first reflector is convex. The first reflector includes a reflective film.

In one or more forms, the system further includes a projector configured to emit the light wherein the projector is configured to project the light based on a lens, the lens having a second principal plane having a third orientation different from the first orientation and the third orientation different from the second orientation, wherein the light is visible on a windshield oriented greater than 60¬∫ from an orientation of the interface.

In one or more forms a system includes a projector configured to emit light. The light is representative of an image. The system includes an interface having a first orientation. The first orientation defines a first geometric plane, and the interface has a substantially planar distribution over the first geometric plane. The system includes a first reflector having a first principal plane. The first principal plane has a second orientation different from the first orientation. The first principal plane defines a first angle of incidence based on the light and a first angle of reflection based on the light. The second reflector has a second principal plane, and the second principal plane has the second orientation. The first structure is configured to orient the first reflector with respect to the interface, and the first structure is configured to orient the second reflector with respect to the interface.

In one or more forms, a system includes a projector configured to emit light. The light is representative of an image. The system includes an interface having a first orientation. The first orientation defines a first geometric plane, and the interface has a substantially planar distribution over the first geometric plane. The system includes a first reflector having a first principal plane. The first principal plane has a second orientation different from the first orientation, and the first principal plane defines a first angle of incidence based on the light and a first angle of reflection based on the light. The system includes a second reflector having a second principal plane, and the second principal plane has a third orientation different form the first orientation and different from the second orientation. The second principal plane defines a second angle of incidence based on the light and a second angle of reflection based on the light. The system includes a first structure configured to orient the first reflector with respect to the interface, and the first structure is configured to orient the second reflector with respect to the interface.

In one or more forms, the system includes a third reflector having a third principal plane. The third principal plane has a fourth orientation different form the first orientation, the second orientation, and the third orientation. The third principal plane defines a third angle of incidence based on the light and a third angle of reflection based on the light. The system includes a second structure configured to orient the third reflector with respect to the interface.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an illustration of a system in accordance with one or more implementations of the present disclosure;

FIG. 2 is an illustration of light rays reflected from an interface in accordance with one or more implementations of the present disclosure;

FIG. 3 is an illustration of light rays diffracted from an interface in accordance with one or more implementations of the present disclosure;

FIG. 4A is an overhead view of an interface and an image in accordance with one or more implementations of the present disclosure;

FIG. 4B is a side view of an interface and a windshield in accordance with one or more implementations of the present disclosure;

FIG. 5 is a side view of one or more portions of an array in accordance with one or more implementations of the present disclosure; and

FIG. 6 is a side view of a reflector in accordance with one or more implementations of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

An interface, as described herein, may be used to reflect and/or diffract light from a projector onto a windshield within a field of view of a passenger of a vehicle. The interface may be situated and configured to allow display on windshields having higher degrees of angle, such as windshield having greater than a 60° angle with respect to a plane associated with the interface, thereby allowing for more flexibility in vehicle design. For example, the interface may use a microlens, microstructure, or micromirror array configured to redirect light or change a direction of a light path from the projector. The microstructure permits granular control over incident light and control over the reflected light. For example, structures may be used to coarsely orient individual mirrors or reflectors of the micromirror array, and each reflector may be individually oriented or configured to reflect portions of the light in the desired direction to an intersection area on the windshield for viewing by the passenger, which may be adjustable in some implementations. The reflectors may be semispherical or substantially semispherical and convex but can take different shapes and forms.

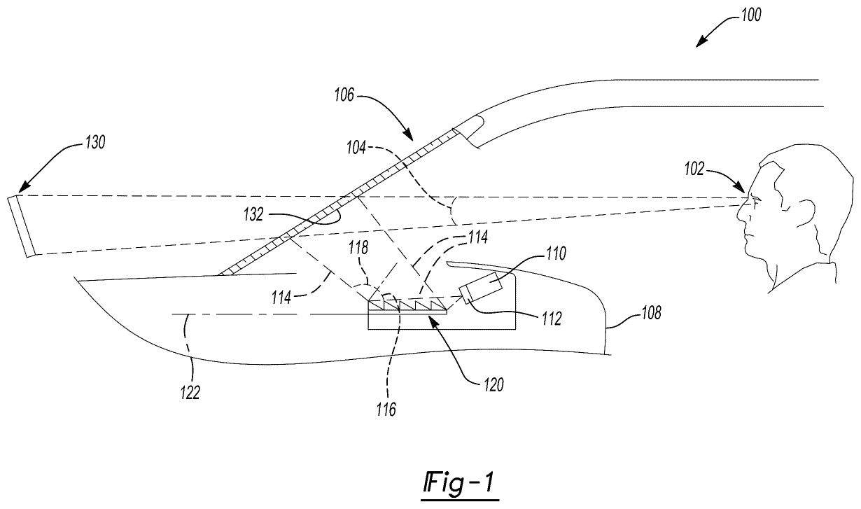

Referring to FIG. 1, a system 100 (e.g., a vehicle) is shown in accordance with one or more implementations of the present disclosure. In some examples, such as when used to display images or information on a windshield 106 of a vehicle, a passenger seated within the vehicle (e.g., driver) is able to view the images or information projected on the windshield. As can be seen, eyes 102 of the occupant of the vehicle have a field of view 104. For example, the field of view 104 may be oriented to the windshield 106, as shown. The system 100 further includes a structural component (e.g., a dashboard 108, console, or another structural component) for supporting a projector 110. It should be noted that although the system 100 is described in connection with a vehicle, the system 100 can be configured and implemented for use in other applications and in other environments.

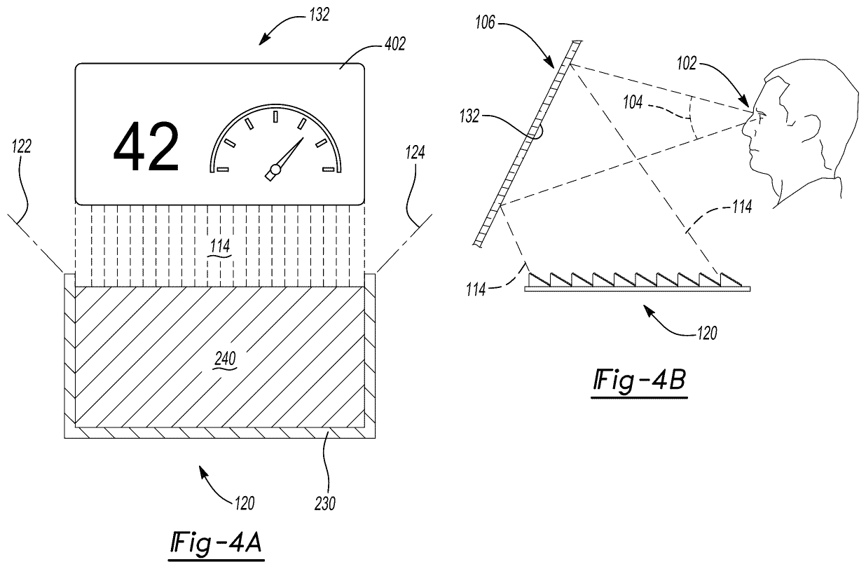

The projector 110 is configured to emit light that generates images and/or causes information to be displayed on the windshield. For example, the light may be projected through a lens 112. The lens 112 may direct light towards an interface 120. The light 114 may be directed based on a principal plane defined by the lens. For example, the principal plane of the lens may be where the light 114 refracts. The lens may include two principal planes and the planes may be parallel. The light is projected to form an image (as shown in FIG. 4A). For example, the projector 110 may be configured to emit light 114 that is representative of graphics, text, numbers, video, information associated with the vehicle, augmented reality information, or other indicia or information. The interface 120 may be substantially planar (e.g., having two longer dimensions and one shorter dimension defining a thickness). For example, the interface 120 may extend about a geometric plane (as shown in FIG. 4A) with axes 122, 124. The interface 120 may have an orientation (e.g., a first orientation, a second orientation, a third orientation, a fourth orientation, a fifth orientation), in three dimensions, with respect to a reference (e.g., the geometric plane).

The interface 120 is configured to direct or redirect the light 114 emitted from the projector 110, such as to reflect or diffract the light 114. For example, the interface 120 may define one or more principal planes (e.g., a first principal plane, a second principal plane, a third principal plane, a fourth principal plane) based on respective reflectors. In some examples, the principal planes may define angles of incidence 116 and angles of reflection 118 that redirect the light 114 from the projector 110 toward the windshield 106. An orientation of the interface 120 may impact the principal plane, and thus, impact the angles of incidence 116 and the angles of reflection 118. The light 114 reflected form the interface 120 and the windshield 106 generates a virtual image 130 within the field of view 104 of the passenger at an intersection 132 of the light 114 reflected from the interface 120 and the windshield 106. The intersection 132 may include four corners (as shown in FIG. 4A). The intersection 132 may be rectangular or substantially rectangular. For example, the intersection 132 may be a distorted rectangle because of the curvature of the windshield 106. In some examples, the windshield 106 may act on the light 114 reflected from the interface 120 as a concave mirror.

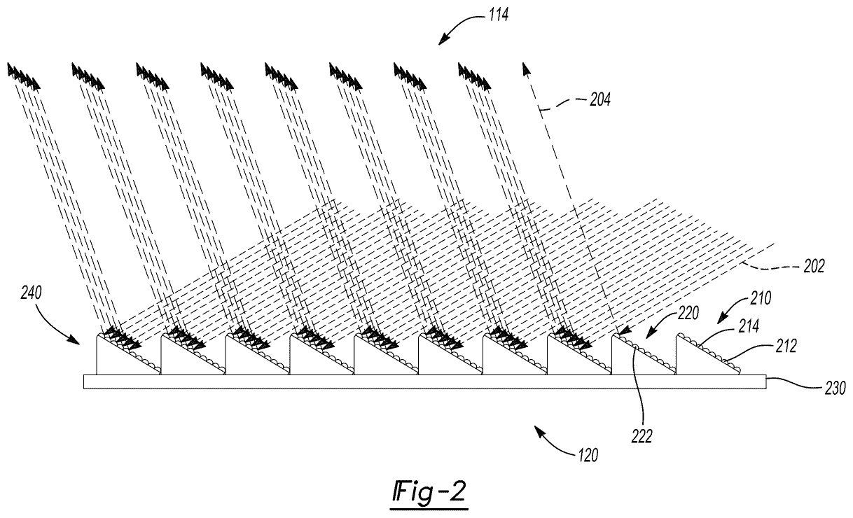

Referring to FIG. 2, the light 114 reflected from the interface 120 is shown in accordance with one or more implementations of the present disclosure. The light 114 is shown as incident rays 202 reflected from interface 120 as reflected rays 204. Although shown to be uniformly incident and reflected, the incident rays 202 and the reflected rays 204 may have different angles of reflection or incidence based on the orientation and configuration of interface 120. For example, the interface 120 includes an array 240 of reflectors 212, 214, 222. The array 240 may be a microlens array or a micromirror array. The array 240 includes structures (e.g., structures 210, 220) for adjusting the inclination of the reflectors 212, 222. Degrees of inclination of the structures 210, 220 may be unique or pseudo-unique to provide the intersection 132 at a desired location on the windshield 106. The structures may define a Fresnel lens. For example, the structure can have the same or similar angles or degrees of inclination in some examples and different angles or degrees of inclination in other examples. Although shown as being uniform or similar, the angle of reflection of the rays 202 may be different to provide the rays 204 reflected are directed to the intersection 132. For example, the orientation (e.g., a first orientation, a second orientation, a third orientation, a fourth orientation, a fifth orientation) of the reflectors 212, 222 may be different from the orientation of the interface 120. The orientation of the reflectors (e.g., the reflectors 212, 222) may also be different from an orientation (e.g., a first orientation, a second orientation, a third orientation, a fourth orientation, a fifth orientation) of the inclination of the structures 210, 220. For example, the reflectors 212, 214 may have different respective angles of reflection 118 for reflected rays 204. The reflectors, 212, 214, 222 and the structures 210, 220 may include gaps or areas of reduced reflection. A light sink 230 also may be situated beneath the reflectors 212, 214, 222 and the structures 210, 220 or opposite the source of light 114 (e.g., the reflectors 212, 214, 222 and structures 210, 220 between the light sink 230 and the source of light 114). The light sink 230 may be matte or flat. The light sink 230 may be colored to absorb light or maximize light absorption (e.g., black).

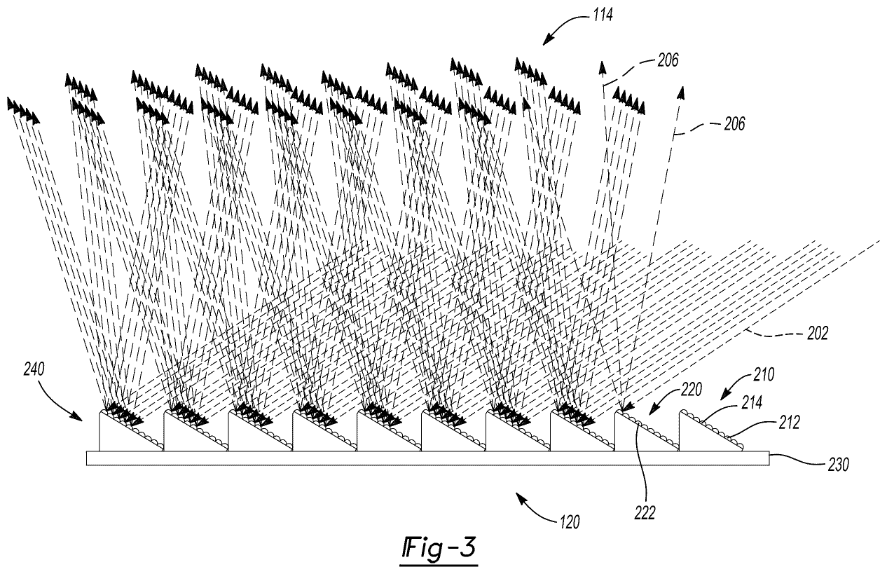

Referring to FIG. 3, the light 114 diffracted from the interface 120 is shown in accordance with one or more implementations of the present disclosure. The reflectors 212, 214, 222 may have imperfect directionality. That is, the reflectors 212, 214, 222 may be convex, as shown, and may diffract incident ray 202 as the diffracted rays 206. The reflectors 212, 214, 222, the structures 210, 220, the interface 120, or a combination thereof may be oriented, arranged, shaped, or configured to reduce the quantity of diffracted rays 206 reaching the intersection 132.

Referring to FIG. 4A-4B, the interface 120 and the intersection 132 are shown in accordance with one or more implementations of the present disclosure. The interface 120 is shown extending over a geometric plane having the axes 122, 124 (FIGS. 4A and 4B). The interface 120 includes the array 240 for reflecting light 114 to generate the image 402 within the field of view 104 of a passenger. FIG. 4A depicts an overhead view of the interface 120 and the image 402 in accordance with one or more implementations of the present disclosure and FIG. 4B is a side view of the interface 120 and the windshield 106 in accordance with one or more implementations of the present disclosure. With one or more implementations described herein, the image 402 is capable of being projected onto the windshield 106 such that the image 402 can be clearly viewed (e.g., having distortion reduced due to the angle of the windshield).

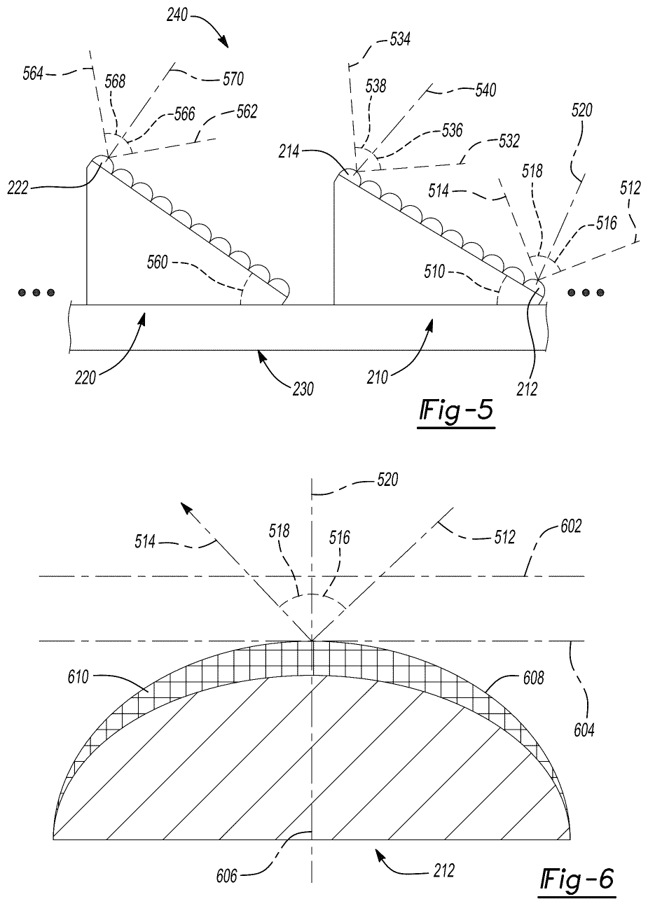

Referring to FIG. 5, a side view of one or more portions of the array 240 is shown in accordance with one or more implementations of the present disclosure. Orientations of the reflectors 212, 214, 222 may not be shown to scale. The reflectors 212, 214 may be situated, disposed, or otherwise integrated with the structure 210. For example, the reflectors 212, 214 may be part of a microarray (e.g., array 240) with an incline 510 common to the reflectors 212, 214. The incline 510 orients the reflectors 212, 214, and other reflectors to an orientation (e.g., a coarse orientation) common to all of the reflectors associated with incline 510 with respect to the geometric plane associated with interface 120 and axes 122, 124. The reflectors 212, 214 may be further oriented on an individual basis (e.g., fine orientation of one or more reflectors 212, 214 independent of other ones of the reflectors 212, 214). For example, the incline 510 may orient reflectors (e.g., reflectors 212, 214) 1° with respect to one or more of the axes 122, 124. The reflector 212 may be oriented, individually, an additional 1° from the incline 510, resulting in an orientation that is 2° offset from the orientation of interface 120. The reflector 214 may be oriented, individually, another 2° from the incline 510, resulting in an orientation that is 3° offset from the orientation of interface 120. Other offsets are contemplated. The incline (e.g., incline 510) may be oriented from the interface 120 in three-dimensional space (e.g., 1° from the axis 122 and 2° from the axis 124). The reflectors (e.g., reflectors 212, 214, 222) may be oriented from the interface 120 in three-dimensional space (e.g., 2° from the axis 122 and 4° from the axis 124).

The reflector 212 is shown positioned to reflect the ray 512 (e.g., have the ray 512 incident thereon) based on light 114 having an angle of incidence 516 with respect to an axis 520. The axis 520 may be normal or orthogonal to a principal plane (e.g., a first principal plane, a second principal plane, a third principal plane, a fourth principal plane) of reflector 212. The reflector 212 is shown positioned to reflect the ray 512 as the ray 514, where the ray 514 has an angle of reflection 518 with respect to the axis 520.

The reflector 214 is shown positioned to receive the ray 532 based on light 114 having an angle of incidence 536 with respect to axis 540. The axis 540 may be normal or orthogonal to a principal plane (e.g., a first principal plane, a second principal plane, a third principal plane, a fourth principal plane) of reflector 214. The reflector 214 is shown positioned to reflect the ray 532 as the ray 534, where the ray 534 has an angle of reflection 538 with respect to the axis 520.

The reflector 222 may be part of a microarray (e.g., array 240) with an incline 560 common to one or more reflectors. The incline 560 orients the reflector 222 and other reflectors to an orientation (e.g., a coarse orientation) common to all of the reflectors associated with incline 560 with respect to the geometric plane associated with the interface 120 and the axes 122, 124. The reflector 222 may be further oriented on an individual basis (e.g., a fine orientation). For example, the incline 560 may orient reflectors (e.g., reflector 222) 1° with respect to one or more of the axes 122, 124. The reflector 222 may be oriented, individually, another 1° from the incline 510 resulting in an orientation that is offset 2° from the orientation of the interface 120. The incline (e.g., incline 560) may be oriented from the interface 120 in three-dimensional space (e.g., 3° from axis 122 and 6° from axis 124). The reflectors (e.g., reflectors 212, 214, 222) may be oriented from the interface 120 in three-dimensional space (e.g., 2° from the axis 122 and 4° from the axis 124).

The reflector 222 is shown positioned to receive the ray 562 based on light 114 having an angle of incidence 566 with respect to an axis 570. The axis 570 may be normal or orthogonal to a principal plane of reflector 222. The reflector 222 is shown positioned to reflect the ray 562 as the ray 564, where the ray 564 has an angle of reflection 568 with respect to the axis 570. The light sink 230 is position between the structures 210, 220 to absorb light that is not reflected by the reflectors 212, 214, 222.

Referring to FIG. 6, a side view of a reflector (e.g., reflector 212, 214, 222) is shown in accordance with one or more implementations of the present disclosure. Each reflector may define a principal plane (e.g., principal plane 602, 604). A reflector (e.g., reflector 212, 214, 222) may be semispherical or substantially semispherical. A semispherical reflector has a principal plane (e.g., principal plane 602, 604) with respect to the angle of incidence (e.g., angle of incidence 516) and the angle of reflectance 518 where the magnitude of the angle of incidence 516 is equal to the magnitude of the angle of reflection 518 with respect to the axis 520 and the principal plane (e.g., principal plane 602, 604) is normal or orthogonal to the axis 520. The size of reflectors (e.g., reflector 212, 214) associated with a structure (e.g., structure 210) may be the same or similar sizes. The size of reflectors (e.g., reflector 212, 214) associated with a structure (e.g., structure 210) may be different sizes (e.g., nonhomogeneous). The structures (e.g., structures 210, 220) may be positioned or oriented to obtain the desired angles of reflection.

The reflector (e.g., reflector 212, 214, 222) may be skewed or shaped nonuniformly with respect to a center 606. For example, the radial distance from the center 606 (or centroid of the hypothetical sphere) may vary with respect to the outer perimeter 608 of reflector 212, 214, 222. With a skewed or non-uniformly shaped reflector (e.g., reflector 212, 214, 222), the principal plane (e.g., principal plane 602, 604) may be defined based on an angle of the reflected light and an intensity of the reflected light (e.g., based on the strongest or group of strongest angles of reflected light). The reflector (e.g., reflector 212, 214, 222) may include a reflective film 610. The film 610 is a part of the interface 120 and may be on the interface instead of the windshield 106. The film 610 is coupled to (e.g., applied to) or forms part of (e.g., integrated with) the interface 120 in some examples as described herein.

In operation, in one or more embodiments, the projector 110 includes a video display controller with memory and at least one processor. The processor is configured to execute instructions stored in the memory to control the output of the projector 110. It is understood that the projector 110 outputs a readable or viewable image, such as the image 402, that is reflected on the windshield 106. Stated differently, the image 402 outputted from the projector 110 reflects off of the film 610 to the windshield 106. The windshield 106 may not require a reflective film or coating, which can add complexity to manufacturing of the windshield. It should be noted that the film 610 can be formed from different materials and be configured differently, such as based on the application, type of windshield, etc. For example, the film 610 can be formed from one or more materials, can have different shapes and sizes, have different thicknesses, have different characteristics (e.g., different transparency), etc.

The film 610 can be combined and/or integrated with the interface 120 in different ways. For example, the film can be coupled to or positioned at different locations or orientations relative to the interface 120. Additionally, the film 610 can be coupled to or combined with the interface 120 using different means, such as different coupling or integrating methods, systems, methods of depositing particulates, or arrangements. The film 610 can be provided on different surfaces or areas of the interface 120. Also, in some examples, multiple films 610 or layers of films 610 are provided.

The video display controller may control the projector 110 to project particular images (e.g., image 402) and/or light based on the instructions stored in the memory and/or based on other inputs from a user. For example, a user input interface and a vehicle input interface may be used to provide instructions to the video display controller to control the projector 110 based on user input and vehicle data/status, respectively. For example, a user input is received in some examples to change a type of information displayed (e.g., to select between instrument data such as speed/RPM/etc. and navigation data such as turn directions), to select options when a graphical user interface is displayed, and/or to otherwise indicate user preferences are provided to the video display controller and processed to alter a content, height, and/or format of the displayed data. It is understood that the user input interface, in some examples, receives user input from any suitable user input device, including but not limited to a touch screen, vehicle-mounted actuators (e.g., buttons, switches, knobs, dials, etc.), a microphone (e.g., for voice commands), an external device (e.g., a mobile device of a vehicle occupant), and/or other user input devices.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system comprising:
an interface having a first orientation, the first orientation defining a first geometric plane, the interface having a substantially planar distribution over the first geometric plane, the interface configured to receive light, wherein the light is representative of an image; and
a first reflector having a first principal plane, the first principal plane having a second orientation different from the first orientation, the first principal plane defining a first angle of incidence based on the light and a first angle of reflection based on the light.

2. The system of claim 1, further comprising:
a first structure configured to orient the first reflector with respect to the interface.

3. The system of claim 2, wherein the first structure forms an incline with respect to the interface and the incline orients the first reflector.

4. The system of claim 3, wherein the incline has a third orientation, the third orientation different from the first orientation and the second orientation.

5. The system of claim 1, further comprising:
a projector; and
a dashboard, wherein the projector and the interface are installed as part of the dashboard and a direction of the first angle of reflection is toward a windshield.

6. The system of claim 5, wherein a direction of the first angle of reflection is toward an intersection between a range of view based on a passenger of a vehicle and the windshield of the vehicle.

7. The system of claim 1, further comprising:
a second reflector having a second principal plane, the second principal plane having a third orientation different from the first orientation and different from the second orientation, the second principal plane defining a second angle of incidence based on the light and a second angle of reflection based on the light.

8. The system of claim 7, further comprising:
a first structure configured to orient the first reflector with respect to the interface and the second reflector with respect to the interface.

9. The system of claim 8, wherein the first structure forms an incline with respect to the interface to orient the first reflector and the second reflector, and the incline has a fourth orientation, the fourth orientation different from the first orientation, the second orientation, and the third orientation.

10. The system of claim 7, further comprising:
a first structure configured to orient the first reflector with respect to the interface; and
a second structure configured to orient the second reflector with respect to the interface.

11. The system of claim 10, wherein the first structure forms a first incline with respect to the interface to orient the first reflector, the first incline having a fourth orientation, the fourth orientation different from the first orientation, the second orientation, and the third orientation, and wherein the second structure forms a second incline with respect to the interface to orient the second reflector, the second incline having a fifth orientation, the fifth orientation different from the first orientation, the second orientation, the third orientation, and the fourth orientation.

12. The system of claim 7, wherein a direction of the first angle of reflection is toward an intersection between a range of view based on a passenger of a vehicle and a windshield of the vehicle and a direction of the second angle of reflection is toward the intersection.

13. The system of claim 12, wherein a geometry of the intersection comprises four corners, the four corners arranged across the windshield of the vehicle.

14. The system of claim 7, wherein the second reflector is convex.

15. The system of claim 1, wherein the first reflector is convex, a direction of the first angle of reflection is toward a windshield, or the first reflector comprises a reflective film.

16. The system of claim 1, further comprising:
a projector configured to emit the light wherein the projector is configured to project the light based on a lens, the lens having a second principal plane having a third orientation different from the first orientation and the third orientation different from the second orientation, wherein the light is visible on a windshield oriented greater than 60° from an orientation of the interface.

17. A system comprising:
a projector configured to emit light, wherein the light is representative of an image;
an interface having a first orientation, the first orientation defining a first geometric plane, the interface having a substantially planar distribution over the first geometric plane;
a first reflector having a first principal plane, the first principal plane having a second orientation different from the first orientation, the first principal plane defining a first angle of incidence based on the light and a first angle of reflection based on the light;
a second reflector having a second principal plane, the second principal plane having the second orientation; and
a first structure configured to orient the first reflector with respect to the interface, the first structure configured to orient the second reflector with respect to the interface.

18. The system of claim 17, wherein a direction of the first angle of reflection is toward an intersection between a range of view based on a passenger of a vehicle and a windshield of the vehicle.

19. The system of claim 18, wherein the first reflector is convex or the first reflector comprises a reflective film.

20. A system comprising:
a projector configured to emit light, wherein the light is representative of an image;
an interface having a first orientation, the first orientation defining a first geometric plane, the interface having a substantially planar distribution over the first geometric plane;
a first reflector having a first principal plane, the first principal plane having a second orientation different from the first orientation, the first principal plane defining a first angle of incidence based on the light and a first angle of reflection based on the light;
a second reflector having a second principal plane, the second principal plane having a third orientation different form the first orientation and different from the second orientation, the second principal plane defining a second angle of incidence based on the light and a second angle of reflection based on the light;
a first structure configured to orient the first reflector with respect to the interface, the first structure configured to orient the second reflector with respect to the interface;
a third reflector having a third principal plane, the third principal plane having a fourth orientation different form the first orientation, the second orientation, and the third orientation, the third principal plane defining a third angle of incidence based on the light and a third angle of reflection based on the light; and
a second structure configured to orient the third reflector with respect to the interface.
